(19) United States
(12) Patent Application Publication
(10) Pub. No.: US 2024/0139886 A1
(43) Pub. Date: May 2, 2024

(54) LASER BONDING OF GLASS CERAMIC TO METAL FOIL

(71) Applicant: CORNING INCORPORATED, CORNING, NY (US)

(72) Inventors: Andrey Kobyakov, Painted Post, NY (US); Stephan Lvovich Logunov, Corning, NY (US)

(21) Appl. No.: 18/378,232

(22) Filed: Oct. 10, 2023

Related U.S. Application Data
(60) Provisional application No. 63/415,375, filed on Oct. 12, 2022.

(51) Int. Cl. B23K 26/57; B23K 26/0622

(52) U.S. Cl. CPC B23K 26/57; B23K 26/0624; B23K 2103/10

(57) ABSTRACT

A method of laser bonding glass ceramic to metal foil includes contacting a first surface of a first glass ceramic substrate with a first surface of a first metal foil to create a first contact location between at least a portion of the first surface of the first glass ceramic substrate and the first surface of the first metal foil; and conducting a first welding step by directing a laser beam on at least a portion of the first contact location to bond the first glass ceramic substrate to the first metal foil and form a first bond location and a package. The first glass ceramic substrate has a thickness greater than or equal to 20 μm and less than or equal to 250 μm. The laser beam comprises a pulsed laser comprising a wavelength greater than or equal to 250 nm and less than or equal to 2 μm.

### CROSS-REFERENCE TO RELATED APPLICATIONS

This application claims the benefit of priority under 35 U.S.C. § 119 of U.S. Provisional Application No. 63/415,375 filed October 12, 2022, the content of which is incorporated herein by reference in its entirety.

### FIELD

The present specification generally relates to glass ceramic bonded to metal foil and, in particular, to laser bonding of glass ceramic to metal foil.

### TECHNICAL BACKGROUND

Hermetically bonded glass or glass ceramic and metal foil packages are increasingly popular for application to electronics and other devices that may benefit from a hermetic environment for sustained operation. However, conventional laser bonding processes may not result in sufficient bonding of glass ceramics.

Accordingly, a need exists for an alternative method to produce laser bonded glass ceramic and metal foil packages having sufficient bond strength.

### SUMMARY

According to a first aspect A1, a method of laser bonding glass ceramic to metal foil may comprise: contacting a first surface of a first glass ceramic substrate with a first surface of a first metal foil to create a first contact location between at least a portion of the first surface of the first glass ceramic substrate and the first surface of the first metal foil; and conducting a first welding step by directing a laser beam on at least a portion of the first contact location to bond the first glass ceramic substrate to the first metal foil and form a first bond location and a package, wherein the first glass ceramic substrate has a thickness greater than or equal to 20 μm and less than or equal to 250 μm, and wherein the laser beam comprises a pulsed laser comprising a wavelength greater than or equal to 250 nm and less than or equal to 2 μm.

A second aspect A2 includes the method according to the first aspect A1, wherein the first glass ceramic substrate a transmission greater than or equal to 50% at a wavelength greater than or equal to 250 nm and less than or equal to 2 μm.

A third aspect A3 includes the method according to the first aspect A1 and the second aspect A2, wherein the first glass ceramic substrate comprises an alumina ceramic substrate or a zirconia ceramic substrate.

A fourth aspect A4 includes the method according to any one of the first through third aspects A1-A3, wherein the first metal foil comprises an aluminum foil.

A fifth aspect A5 includes the method according to the fourth aspect A4, wherein the first metal foil further comprises a metal other than aluminum.

A sixth aspect A6 includes the method according to any one of the first through fifth aspects A1-A5, wherein the first metal foil has a thickness greater than or equal to 10 μm and less than or equal to 100 μm.

A seventh aspect A7 includes the method according to any one of the first through sixth aspects A1-A6, wherein the pulsed laser has a power density less than or equal to 6 J/cm 2 .

An eighth aspect A8 includes the method according to any one of the first through seventh aspects A1-A7, wherein the pulsed laser is a nanosecond pulsed laser, a picosecond pulsed laser, or a femtosecond pulsed laser.

A ninth aspect A9 includes the method according to the eighth aspect A8, wherein the pulsed laser has a pulse width greater than or equal to 1 ns and less than or equal to 30 ns.

A tenth aspect A10 includes the method according to the eighth aspect A8, wherein the pulsed laser has a pulse width greater than or equal to 10 ps.

An eleventh aspect A11 includes the method according to the eighth aspect A8, wherein the pulsed laser has a pulse width less than or equal to 1 ps.

A twelfth aspect A12 includes the method according to any one of the first through eleventh aspects A1-A11, wherein the pulsed laser has a repetition rate greater than or equal to 1 kHz and less than or equal to 800 kHz.

A thirteenth aspect A13 includes the method according to any one of the first through twelfth aspects A1-A12, wherein the pulsed laser has a spot size greater than or equal to 10 μm and less than or equal to 200 μm.

A fourteenth aspect A14 includes the method according to any one of the first through thirteenth aspects A1-A13, wherein the package has a bond strength greater than or equal to 3 MPa.

A fifteenth aspect A15 includes the method according to any one of the first through fourteenth aspects A1-A14, wherein the package has a bend radius less than or equal to 30 cm.

A sixteenth aspect A16 includes the method according to any one of the first through fifteenth aspects A1-A15, wherein the first bond location has a maximum bond depth less than or equal to 2 μm.

A seventeenth aspect A17 includes the method according to any one of the first through sixteenth aspects A1-A16, wherein the package has a parabolic cylinder shape.

An eighteenth aspect A18 includes the method according to the seventeenth aspect A17, wherein the package is a parabolic reflector antenna.

A nineteenth aspect A19 includes the method according to any one of the first through sixteenth aspects A1-A16, further comprising: contacting a second surface of the first glass ceramic substrate with a first surface of a second metal foil to create a second contact location between at least a portion of the second surface of the first glass ceramic substrate and the first surface of the second metal foil; and conducting a second welding step by directing the laser beam on at least a portion of the second contact location to bond the first glass ceramic substrate to the second metal foil and form a second bond location.

A twentieth aspect A20 includes the method according to the nineteenth aspect A19, further comprising: forming a pattern on at least one of the first metal foil and the second metal foil to form a patterned metal foil.

A twenty-first aspect A21 includes the method according to the twentieth aspect A20, wherein the package is a printed antenna.

A twenty-second aspect A22 includes the method according to any one of the first through sixteenth aspects A1-A16, further comprising: contacting a first surface of a second glass ceramic substrate with the first surface of the first metal foil to create a second contact location between at least a portion of the first surface of the second glass ceramic substrate and the first surface of the first metal foil; and conducting a second welding step by directing the laser beam on at least a portion of the second contact location to bond the second glass ceramic substrate to the first metal foil and form a second bond location, wherein the first metal foil connects the first glass ceramic substrate and the second glass ceramic substrate.

A twenty-third aspect A23 includes the method according to the twenty-second aspect A22, wherein the package is a corner reflector.

A twenty-fourth aspect A24 includes the method according to any one of the first through twenty-third aspects A1-A23, wherein the metal foil comprises a melting point less than or equal to 1200 ° C.

A twenty-fifth aspect A25 includes the method according to any one of the first through twenty-fourth aspects A1-A24, wherein the laser beam is directed at an oblique angle of incidence relative to the first glass ceramic substrate.

A twenty-sixth aspect A25 includes the method according to the twenty-fifth aspect A25, wherein the oblique angle of incidence is less than or equal to 45° .

Additional features and advantages of the laser bonding methods described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a flow diagram of a method of laser bonding glass ceramic to metal foil, according to one or more embodiments shown and described herein;

FIG. 2 schematically depicts a step of the laser bonding method, according to one or more embodiments shown and described herein;

FIG. 3 schematically depicts another step of the laser bonding method, according to one or more embodiments shown and described herein;

FIG. 4 schematically depicts a top view of the step shown in FIG. 3;

FIG. 5 schematically depicts a bent glass ceramic and metal foil package, according to one or more embodiments shown and described herein;

FIG. 6 is a photograph of a bent glass ceramic and metal foil package, according to one or more embodiments shown and described herein;

FIG. 7 is another photograph of the bent package of FIG. 6;

FIG. 8 schematically depicts a parabolic reflector antenna, according to one or more embodiments shown and described herein;

FIG. 9 is a graph of a bent package for different values of relative displacement, according to one or more embodiments shown and described herein;

FIG. 10 is a scanning electron microscope image of metal foil bonded to glass ceramic, according to one or more embodiments shown and described herein;

FIG. 11 schematically depicts another step of the laser bonding method, according to one or more embodiments shown and described herein;

FIG. 12 schematically depicts another step of the laser bonding method, according to one or more embodiments shown and described herein;

FIG. 13 schematically depicts an individual component of a retroreflector, according to one or more embodiments shown and described herein;

FIG. 14 schematically depicts a retroreflector, according to one or more embodiments shown and described herein; and

FIG. 15 is a graph of wavelength (x-axis: wavelength (nm)) versus transmission (y- axis (%)) of glass ceramic substrates, according to one or more embodiments shown and described herein.

### DETAILED DESCRIPTION

Reference will now be made in detail to various embodiments of methods of laser bonding glass ceramics to metal foil. According to embodiments, a method of laser bonding glass ceramic to metal foil includes contacting a first surface of a first glass ceramic substrate with a first surface of a first metal foil to create a first contact location between at least a portion of the first surface of the first glass ceramic substrate and the first surface of the first metal foil; and conducting a first welding step by directing a laser beam on at least a portion of the first contact location to bond the first glass ceramic substrate to the first metal foil and form a first bond location and a package. The first glass ceramic substrate has a thickness greater than or equal to 20 μm and less than or equal to 250 μm. The laser beam comprises a pulsed laser comprising a wavelength greater than or equal to 250 nm and less than or equal to 2 μm. Various embodiments of laser bonding glass ceramic to metal foil and packages formed therefrom will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

“Hermetically bonded” or “hermetically sealed,” as described herein, refers to a package that includes a hermetic seal in accordance with MIL-STD-750E, Test Method 1071.9. In embodiments, the hermetically sealed package may not include any adhesive (e.g., epoxy).

“Bond strength,” as described herein, refers to the strength between the glass ceramic substrate and the metal foil as measured according to ASTM C297.

The terms “sufficient bond” or “sufficient bond strength,” as used herein, refer to a bond strength greater than or equal to 3 MPa.

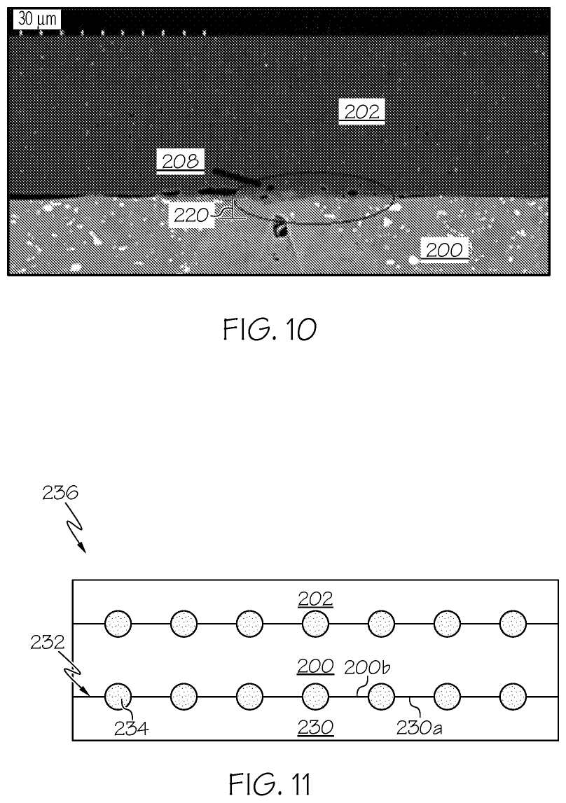

“Maximum bond depth,” as described herein and determined using scanning electron microscopy, refers to a depth of the glass ceramic substrate/metal foil interface within the glass ceramic substrate as shown in FIG. 10.

“Transmission,” as described herein, refers to diffused transmission as measured according to Andreas Höpe, Experimental Methods in the Physical Sciences, Vol. 46, p. 179- 219 (2014), with a wavelength range of 250 nm to 2 μm.

Hermetically bonded glass or glass ceramic and metal foil packages may be used in devices which benefit from hermetic packaging, such as televisions, sensors, optical devices, organic light emitting diode (OLED) displays, 3D inkjet printers, solid-state lighting sources, batteries, and photo-voltaic structures. Conventional laser bonding processes may not result in sufficient bonding (e.g., bond strength greater than or equal to 3 MPa) of glass ceramics. In particular, manufacturing processes used to produce glass ceramics do not form a uniform surface, making it difficult to achieve a sufficient bond without machining the glass ceramic to flatten and even out the surface thereof. Moreover, unlike glass, the relatively high melting temperature of glass ceramics prevents melting the glass ceramic to bond the material to a foil.

Disclosed herein are methods of laser bonding glass ceramic to metal foil which mitigate the aforementioned problems such that packages having sufficient bond strength are formed. Specifically, the methods of laser bonding glass ceramic to metal foil disclosed herein utilize relatively thin glass ceramics (e.g., greater than or equal to 20 μm and less than or equal to 250 μm) and laser beams having a relatively shorter wavelength (e.g., greater than or equal to 250 nm and less than or equal to 2 μm) to produce packages having sufficient bond strength (e.g., greater than or equal to 3 MPa).

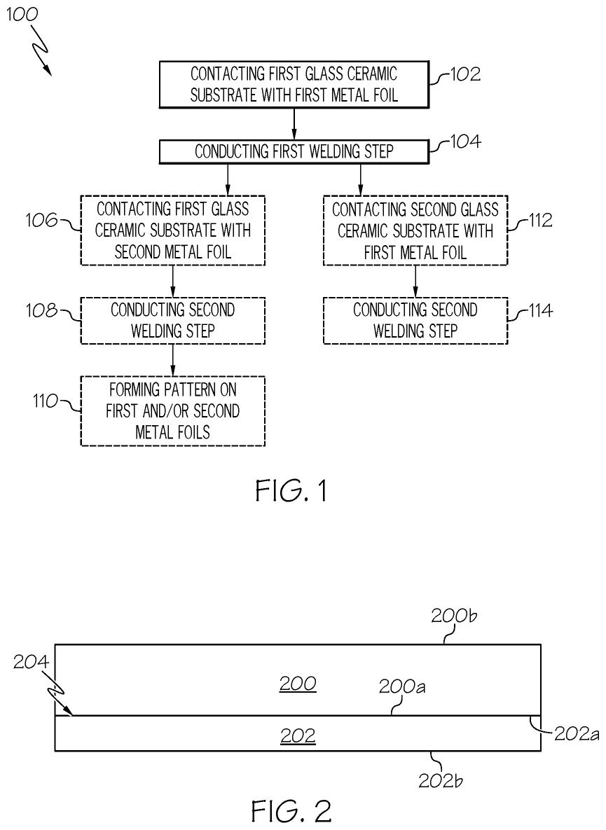

Referring now to FIGS. 1 and 2, a method of laser bonding glass ceramic to metal foil 100 begins with contacting a first surface 200a of a first glass ceramic substrate 200 with a first surface 202a of a first metal foil 202 to a create a first contact location 204 between at least a portion of the first surface 200a of the first glass ceramic substrate 200 and the first surface 202a of the first metal foil 202. Each of the first glass ceramic substrate 200 and the first metal foil 202 have a second surface 200b, 202b opposite the first surface 200a, 202a.

The inherent structure of glass ceramic causes light directed at the material to scatter. To account for this, a thickness of the first glass ceramic substrate 200 may be limited (e.g., less than or equal to 250 μm) to ensure that even with some scattering, enough light from a laser beam directed through the first glass ceramic substrate 200 is delivered to sufficiently bond the first glass ceramic substrate 200 to the first metal foil 202. Accordingly, in embodiments, the first glass ceramic substrate 200 may have a thickness greater than or equal to 20 μm and less than or equal to 250 μm. In embodiments, the first glass ceramic substrate 200 may have a thickness greater than or equal to 20 μm, greater than or equal to 40 μm, greater than or equal to 60 μm, or even greater than or equal to 80 μm. In embodiments, the first glass ceramic substrate 200 may have a thickness less than or equal to 250 μm, less than or equal to 200 μm, less than or equal to 180 μm, less than or equal to 160 μm, less than or equal to 140 μm, less than or equal to 120 μm, or even less than or equal to 100 μm. In embodiments, the first glass ceramic substrate 200 may have a thickness greater than or equal to 20 μm and less than or equal to 250 μm, greater than or equal to 20 μm and less than or equal to 200 μm, greater than or equal to 20 μm and less than or equal to 180 μm, greater than or equal to 20 μm and less than or equal to 160 μm, greater than or equal to 20 μm and less than or equal to 140 μm, greater than or equal to 20 μm and less than or equal to 120 μm, greater than or equal to 20 μm and less than or equal to 100 μm, greater than or equal to 40 μm and less than or equal to 250 μm, greater than or equal to 40 μm and less than or equal to 200 μm, greater than or equal to 40 μm and less than or equal to 180 μm, greater than or equal to 40 μm and less than or equal to 160 μm, greater than or equal to 40 μm and less than or equal to 140 μm, greater than or equal to 40 μm and less than or equal to 120 μm, greater than or equal to 40 μm and less than or equal to 100 μm, greater than or equal to 60 μm and less than or equal to 250 μm, greater than or equal to 60 μm and less than or equal to 200 μm, greater than or equal to 60 μm and less than or equal to 180 μm, greater than or equal to 60 μm and less than or equal to 160 μm, greater than or equal to 60 μm and less than or equal to 140 μm, greater than or equal to 60 μm and less than or equal to 120 μm, greater than or equal to 60 μm and less than or equal to 100 μm, greater than or equal to 80 μm and less than or equal to 250 μm, greater than or equal to 80 μm and less than or equal to 200 μm, greater than or equal to 80 μm and less than or equal to 180 μm, greater than or equal to 80 μm and less than or equal to 160 μm, greater than or equal to 80 μm and less than or equal to 140 μm, greater than or equal to 80 μm and less than or equal to 120 μm, or even greater than or equal to 80 μm and less than or equal to 100 μm, or any and all sub-ranges formed from any of these endpoints.

In embodiments, to ensure that enough light from a laser beam is delivered to sufficiently bond the first glass ceramic substrate 200 to the first metal foil 202, a thickness of the first glass ceramic substrate 200 should be adjusted such that the first glass ceramic substrate 200 has a transmission greater than or equal to 50% at a wavelength greater than or equal to 250 nm and less than or equal to 2 μm. In embodiments, the first glass ceramic substrate 200 may have a transmission greater than or equal to 50%, greater than or equal to or equal to 55%, greater than or equal to 60%, or even greater than or equal to 65%, at a wavelength greater than or equal to 250 nm and less than or equal to 2 μm.

In embodiments, the first glass ceramic substrate 200 may comprise an alumina ceramic substrate or a zirconia ceramic substrate.

In embodiments, the first glass ceramic substrate 200 may comprise a coating thereon (not shown). In embodiments, the coating may comprise a polymer coating, an antireflection (AR) coating, an oliphobic coating, an antiglare coating, or a scratch resistant coating.

In embodiments, prior to bonding of the glass ceramic to a metal foil, the first glass ceramic substrate 200 may be cleaned with water and/or solvents to remove any debris present on the surface and/or to remove any material (oil, grease, etc.) which may diminish the transmission of the laser beam. Removal of any debris may allow the first glass ceramic substrate 200 to be placed in close contact with the first metal foil 202 to better facilitate laser bonding of the first metal foil 202 to the first glass ceramic substrate 200.

In embodiments, the first metal foil 202 may comprise an aluminum foil. In embodiments, the first metal foil 202 may be formed from a material that is chemically compatible (i.e., bond readily) to the first glass ceramic substrate 200. For example, a glass ceramic including aluminum may more readily bond to an aluminum metal foil. In embodiments, a glass ceramic including zirconia may bond to an aluminum metal foil.

In embodiments, the first metal foil 202 may be a multilayer foil. For example, in embodiments, the first metal foil 202 may comprise a first layer comprising an aluminum foil and a second layer comprising metal other than aluminum, such as copper or silver. Multilayer foils may be used in applications where foil conductivity is important to achieving the desired result.

In embodiments, the first metal foil 202 may be formed from a material that has a melting point that allows for successful bonding to the glass ceramic substrate. In embodiments, the first metal foil 202 may comprise a melting point less than or equal to 1200 ° C., less than or equal to 1000 ° C., less than or equal to 800 ° C., or even less than or equal to 700 ° C.

In embodiments, the first metal foil 202 may be formed from a material that is substantially opaque to a selected wavelength of a laser beam. The term “substantially opaque” means that the material is substantially not transparent at the wavelength of the laser. For example, in embodiments, a material that is substantially opaque to a wavelength of a laser beam may be a material that exhibits a transmittance less than or equal to 35% at the given wavelength and at an article thickness of 50 μm.

In embodiments, the first metal foil 202 may have a thickness greater than or equal to 10 μm and less than or equal to 100 μm. In embodiments, the first metal foil 202 may have a thickness greater than or equal to 10 μm, greater than or equal to 15 μm, greater than or equal to 20 μm, or even greater than or equal to 25 μm. In embodiments, the first metal foil 202 may have a thickness less than or equal to 100 μm, less than or equal to 80 μm, less than or equal to 60 μm, or even less than or equal to 40 μm, or any and all sub-ranges formed from any of these endpoints. In embodiments, the first metal foil 202 may have a thickness greater than or equal to 10 μm and less than or equal to 100 μm, greater than or equal to 10 μm and less than or equal to 80 μm, greater than or equal to 10 μm and less than or equal to 60 μm, greater than or equal to 10 μm and less than or equal to 40 μm, greater than or equal to 15 μm and less than or equal to 100 μm, greater than or equal to 15 μm and less than or equal to 80 μm, greater than or equal to 15 μm and less than or equal to 60 μm, greater than or equal to 15 μm and less than or equal to 40 μm, greater than or equal to 20 μm and less than or equal to 100 μm, greater than or equal to 20 μm and less than or equal to 80 μm, greater than or equal to 20 μm and less than or equal to 60 μm, greater than or equal to 20 μm and less than or equal to 40 μm, greater than or equal to 25 μm and less than or equal to 100 μm, greater than or equal to 25 μm and less than or equal to 80 μm, greater than or equal to 25 μm and less than or equal to 60 μm, or even greater than or equal to 25 μm and less than or equal to 40 μm, or any and all sub-ranges formed from any of these endpoints.

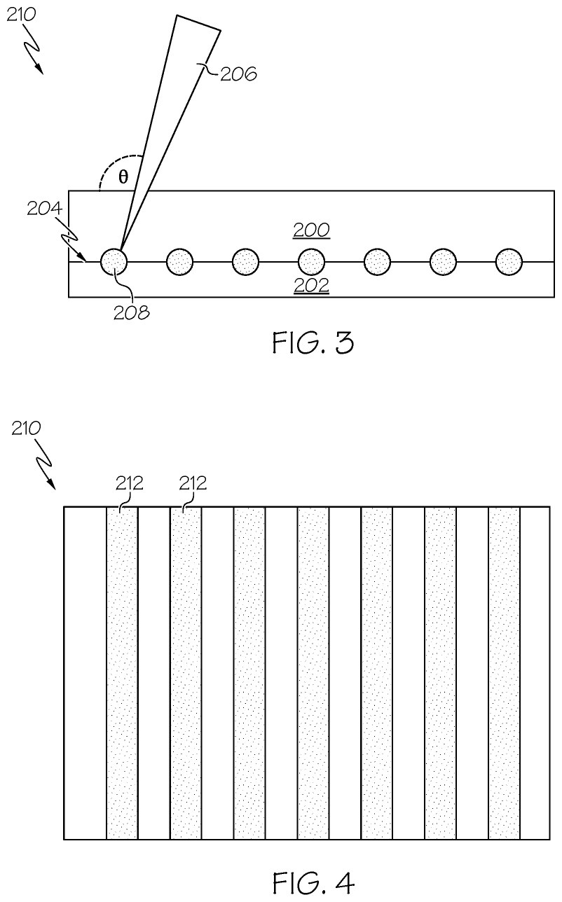

Referring back to FIG. 1 and as shown in FIGS. 3 and 4, the method 100 continues at block 104 with conducting a first welding step by directing a laser beam 206 on at least a portion of the first contact location 204 to bond the first glass ceramic substrate 200 and the first metal foil 202 and form a first bond location 208 and a package 210.

In embodiments, the method 100 may optionally include bonding a second glass ceramic substrate (not shown) to the first metal foil 202 opposite the first glass ceramic substrate 200 such that the package 210 is a glass ceramic substrate/metal foil/ glass ceramic substrate sandwich.

Due to the relatively thin glass ceramics (e.g., greater than or equal to 20 μm and less than or equal to 250 μm) used herein, laser beams having relatively shorter wavelengths may be used while ensuring that enough light from a laser beam directed through the first glass ceramic substrate 200 is delivered to sufficiently bond the first glass ceramic substrate 200 to the first metal foil 202. Accordingly, in embodiments, the laser beam 206 may comprise a pulsed laser comprising a wavelength greater than or equal to 250 nm and less than or equal to 2 μm. In embodiments, the pulsed laser may comprise a wavelength greater than or equal to 250 nm, greater than or equal to 300 nm, greater than or equal to 350 nm, or even greater than or equal to 400 nm. In embodiments, the pulsed laser may comprise a wavelength less than or equal to 2 μm, less than or equal to 1 μm, less than or equal to 800 nm, or even less than or equal to 600 nm. In embodiments, the pulsed laser may comprise a wavelength greater than or equal to 250 nm and less than or equal to 2 μm, greater than or equal to 250 nm and less than or equal to 1 μm, greater than or equal to 250 nm and less than or equal to 800 nm, greater than or equal to 250 nm and less than or equal to 600 nm, greater than or equal to 300 nm and less than or equal to 2 μm, greater than or equal to 300 nm and less than or equal to 1 μm, greater than or equal to 300 nm and less than or equal to 800 nm, greater than or equal to 300 nm and less than or equal to 600 nm, greater than or equal to 350 nm and less than or equal to 2 μm, greater than or equal to 350 nm and less than or equal to 1 μm, greater than or equal to 350 nm and less than or equal to 800 nm, greater than or equal to 350 nm and less than or equal to 600 nm, greater than or equal to 400 nm and less than or equal to 2μm, greater than or equal to 400 nm and less than or equal to 1 μm, greater than or equal to 400 nm and less than or equal to 800 nm, or even greater than or equal to 400 nm and less than or equal to 600 nm, or any and all sub-ranges formed from any of these endpoints.

In embodiments, the pulsed laser may have a power density less than or equal to 6 J/cm 2 . In embodiments, the pulsed laser may have a power density greater than or equal to 3 J/cm 2 , greater than or equal to 3.5 J/cm 2 , or even greater than or equal to 4 J/cm 2 . In embodiments, the pulsed laser may have a power density less than or equal to 6 J/cm 2 , less than or equal to 5.5 J/cm 2 , less than or equal to 5 J/cm 2 , or even less than or equal to 4.5 J/cm 2 . In embodiments, the pulsed laser has a power density greater than or equal to 3 J/cm 2 and less than or equal to 6 J/cm 2 , greater than or equal to 3 J/cm 2 and less than or equal to 5.5 J/cm 2 , greater than or equal to 3 J/cm 2 and less than or equal to 5 J/cm 2 , greater than or equal to 3 J/cm 2 and less than or equal to 4.5 J/cm 2 , greater than or equal to 3.5 J/cm 2 and less than or equal to 6 J/cm 2 , greater than or equal to 3.5 J/cm 2 and less than or equal to 5.5 J/cm 2 , greater than or equal to 3.5 J/cm 2 and less than or equal to 5 J/cm 2 , greater than or equal to 3.5 J/cm 2 and less than or equal to 4.5 J/cm 2 , greater than or equal to 4 J/cm 2 and less than or equal to 6 J/cm 2 , greater than or equal to 4 J/cm 2 and less than or equal to 5.5 J/cm 2 , greater than or equal to 4 J/cm 2 and less than or equal to 5 J/cm 2 , or even greater than or equal to 4 J/cm 2 and less than or equal to 4.5 J/cm 2 , or any and all sub-ranges formed from any of these endpoints.

In embodiments, the pulsed laser may be a nanosecond pulsed laser, a picosecond pulsed laser, or a femtosecond pulsed laser. For example, in embodiments, the pulsed laser may have a pulse width greater than or equal to 1 ns and less than or equal to 30 ns. In embodiments, the pulsed laser may have a pulse width greater than or equal to 10 ps. In embodiments, the pulsed laser may have a pulse width less than or equal to 1 ps.

In embodiments, the pulsed laser may have a repetition rate greater than or equal to 1 kHz and less than or equal to 800 kHz. In embodiments, the pulsed laser may have a repetition rate greater than or equal to 1 kHz, greater than or equal to 10 kHz, greater than or equal to 20 kHz, or even greater than or equal to 30 kHz. In embodiments, the pulsed laser may have a repetition rate less than or equal to 800 kHz, less than or equal to 600 kHz, less than or equal to 400 kHz, less than or equal to 200 kHz, less than or equal to 150 kHz, less than or equal to 100 kHz, or even less than or equal to 50 kHz. In embodiments, the pulsed laser may have a repetition rate greater than or equal to 1 kHz and less than or equal to 800 kHz, greater than or equal to 1 kHz and less than or equal to 600 kHz, greater than or equal to 1 kHz and less than or equal to 400 kHz, greater than or equal to 1 kHz and less than or equal to 200 kHz, greater than or equal to 1 kHz and less than or equal to 150 kHz, greater than or equal to 1 kHz and less than or equal to 100 kHz, greater than or equal to 1 kHz and less than or equal to 50 kHz, greater than or equal to 10 kHz and less than or equal to 800 kHz, greater than or equal to 10 kHz and less than or equal to 600 kHz, greater than or equal to 10 kHz and less than or equal to 400 kHz, greater than or equal to 10 kHz and less than or equal to 200 kHz, greater than or equal to 10 kHz and less than or equal to 150 kHz, greater than or equal to 10 kHz and less than or equal to 100 kHz, greater than or equal to 10 kHz and less than or equal to 50 kHz, greater than or equal to 20 kHz and less than or equal to 800 kHz, greater than or equal to 20 kHz and less than or equal to 600 kHz, greater than or equal to 20 kHz and less than or equal to 400 kHz, greater than or equal to 20 kHz and less than or equal to 200 kHz, greater than or equal to 20 kHz and less than or equal to 150 kHz, greater than or equal to 20 kHz and less than or equal to 100 kHz, greater than or equal to 20 kHz and less than or equal to 50 kHz, greater than or equal to 30 kHz and less than or equal to 800 kHz, greater than or equal to 30 kHz and less than or equal to 600 kHz, greater than or equal to 30 kHz and less than or equal to 400 kHz, greater than or equal to 30 kHz and less than or equal to 200 kHz, greater than or equal to 30 kHz and less than or equal to 150 kHz, greater than or equal to 30 kHz and less than or equal to 100 kHz, or even greater than or equal to 30 kHz and less than or equal to 50 kHz, or any and all sub-ranges formed from any of these endpoints.

In embodiments, the pulsed laser may have a spot size greater than or equal to 10 μm and less than or equal to 200 μm. In embodiments, the pulsed laser may have a spot size greater than or equal to 10 μm, greater than or equal to 20 μm, or even greater than or equal to 30 μm. In embodiments, the pulsed laser may have a spot size less than or equal to 200 μm, less than or equal to 150 μm, less than or equal to 100 μm, or even less than or equal to 50 μm. In embodiments, the pulsed laser may have a spot size greater than or equal to 10 μm and less than or equal to 200 μm, greater than or equal to 10 μm and less than or equal to 150 μm, greater than or equal to 10 μm and less than or equal to 100 μm, greater than or equal to 10 μm and less than or equal to 50 μm, greater than or equal to 20 μm and less than or equal to 200 μm, greater than or equal to 20 μm and less than or equal to 150 μm, greater than or equal to 20 μm and less than or equal to 100 μm, greater than or equal to 20 μm and less than or equal to 50 μm, greater than or equal to 30 μm and less than or equal to 200 μm, greater than or equal to 30 μm and less than or equal to 150 μm, greater than or equal to 30 μm and less than or equal to 100 μm, or even greater than or equal to 30 μm and less than or equal to 50 μm, or any and all sub-ranges formed from any of these endpoints.

In embodiments, the laser beam 206 may be directed at an oblique angle of incidence θ relative to the first glass substrate 200. In embodiments, the oblique angle of incidence θ may be less than or equal to 45°

In embodiments, as shown in FIG. 3, during the first welding step, the first metal foil 202 is disposed optically downstream of the first glass ceramic substrate 200 such that the laser beam 206 passes through the first glass ceramic substrate 200 before being incident on the first contact location 204. The laser beam 206 may be traversed along the first contact location 204 to facilitate a line bond between the glass ceramic and foil. For example, the laser beam may be traversed along the first contact location 204 (e.g., into and/or out of the page and/or transverse to the plane of the page in FIG. 3) to facilitate a line bond between the glass and foil.

In embodiments, the first bond location 208 may be a hermetic seal between the first glass ceramic substrate 200 and the first metal foil 202. The first bond location 208 may be any shape that ensures sufficient bonding between the first glass ceramic substrate 200 and the first metal foil 202. For example, in embodiments, the first bond location 208 may comprise weld lines 212.

In embodiments, the weld lines 212 may have a width greater than or equal to 5 μm and less than or equal to 1 mm. In embodiments, the weld lines 216 may have a width greater than or equal to 5 μm, greater than or equal to 15 μm, or even greater than or equal to 25 μm. In embodiments, the weld lines 212 may have a width less than or equal to 1 mm, less than or equal to 750 μm, less than or equal to 500 μm, less than or equal to 250 μm, or even less than or equal to 100 μm. In embodiments, the weld lines 212 may have a width greater than or equal to 5 μm and less than or equal to 1 mm, greater than or equal to 5 μm and less than or equal to 750 μm, greater than or equal to 5 μm and less than or equal to 500 μm, greater than or equal to 5 μm and less than or equal to 250 μm, greater than or equal to 5 μm and less than or equal to 100 μm, greater than or equal to 15 μm and less than or equal to 1 mm, greater than or equal to 15 μm and less than or equal to 750 μm, greater than or equal to 15 μm and less than or equal to 500 μm, greater than or equal to 15 μm and less than or equal to 250 μm, greater than or equal to 15 μm and less than or equal to 100 μm, greater than or equal to 25 μm and less than or equal to 1 mm, greater than or equal to 25 μm and less than or equal to 750 μm, greater than or equal to 25 μm and less than or equal to 500 μm, greater than or equal to 25 μm and less than or equal to 250 μm, or even greater than or equal to 25 μm and less than or equal to 100 μm, or any and all sub-ranges formed from any of these endpoints.

In embodiments, the weld lines 212 may be evenly spaced apart (i.e., have a same distance between them) or unevenly spaced apart (i.e., have a different distance between them). In embodiments, a distance between weld lines 212 may be greater than or equal to 1 μm and less than or equal to 1000 μm. In embodiments, a distance between weld lines 212 may be greater than or equal to 1 μm, greater than or equal to 10 μm, greater than or equal to 25 μm, or even greater than or equal to 50 μm. In embodiments, a distance between weld lines 212 may be less than or equal to 1000 μm, less than or equal to 750 μm, less than or equal to 500 μm, less than or equal to 250 μm, or even less than or equal to 100 μm. In embodiments, a distance between weld lines 212 may be greater than or equal to 1 μm and less than or equal to 1000 μm, greater than or equal to 1μm and less than or equal to 750 μm, greater than or equal to 1μm and less than or equal to 500 μm, greater than or equal to 1 μm and less than or equal to 250 μm, greater than or equal to 1 μm and less than or equal to 100 μm, greater than or equal to 10 μm and less than or equal to 1000 μm, greater than or equal to 10 μm and less than or equal to 750 μm, greater than or equal to 10 μm and less than or equal to 500 μm, greater than or equal to 10 μm and less than or equal to 250 μm, greater than or equal to 10 μm and less than or equal to 100 μm, greater than or equal to 25 μm and less than or equal to 1000 μm, greater than or equal to 25 μm and less than or equal to 750 μm, greater than or equal to 25 μm and less than or equal to 500 μm, greater than or equal to 25 μm and less than or equal to 250 μm, greater than or equal to 25 μm and less than or equal to 100 μm, greater than or equal to 50 μm and less than or equal to 1000 μm, greater than or equal to 50 μm and less than or equal to 750 μm, greater than or equal to 50 μm and less than or equal to 500 μm, greater than or equal to 50 μm and less than or equal to 250 μm, or even greater than or equal to 50 μm and less than or equal to 100 μm, or any and all sub-ranges formed from any of these endpoints.

As described herein, the methods of laser bonding glass ceramic to metal foil disclosed herein utilize relatively thin glass ceramics (e.g., greater than or equal to 20 μm and less than or equal to 250 μm) and laser beams having a relatively shorter wavelength (e.g., greater than or equal to 250 nm and less than or equal to 2 μm) to produce packages having sufficient bond strength (e.g., bond strength greater than or equal to 3 MPa). In embodiments, the package 210 may have a bond strength greater than or equal to 3 MPa, greater than or equal to 4 MPa, greater than or equal to 5 MPa greater than or equal to 6 MPa, greater than or equal to 7 MPa, greater than or equal to 8 MPa, greater than or equal to 9 MPa, or even greater than or equal to 10 MPa. In embodiments, the package 210 may have a bond strength less than or equal to 25 MPa, less than or equal to 20 MPa, or even less than or equal to 15 MPa. In embodiments, the package 210 may have a bond strength greater than or equal to 3 MPa and less than or equal to 25 MPa, greater than or equal to 3 MPa and less than or equal to 20 MPa, greater than or equal to 3 MPa and less than or equal to 15 MPa, greater than or equal to 4 MPa and less than or equal to 25 MPa, greater than or equal to 4 MPa and less than or equal to 20 MPa, greater than or equal to 4 MPa and less than or equal to 15 MPa, greater than or equal to 5 MPa and less than or equal to 25 MPa, greater than or equal to 5 MPa and less than or equal to 20 MPa, greater than or equal to 5 MPa and less than or equal to 15 MPa, greater than or equal to 6 MPa and less than or equal to 25 MPa, greater than or equal to 6 MPa and less than or equal to 20 MPa, greater than or equal to 6 MPa and less than or equal to 15 MPa, greater than or equal to 7 MPa and less than or equal to 25 MPa, greater than or equal to 7 MPa and less than or equal to 20 MPa, greater than or equal to 7 MPa and less than or equal to 15 MPa, greater than or equal to 8 MPa and less than or equal to 25 MPa, greater than or equal to 8 MPa and less than or equal to 20 MPa, greater than or equal to 8 MPa and less than or equal to 15 MPa, greater than or equal to 9 MPa and less than or equal to 25 MPa, greater than or equal to 9 MPa and less than or equal to 20 MPa, greater than or equal to 9 MPa and less than or equal to 15 MPa, greater than or equal to 10 MPa and less than or equal to 25 MPa, greater than or equal to 10 MPa and less than or equal to 20 MPa, or even greater than or equal to 10 MPa and less than or equal to 15 MPa, or any and all sub-ranges formed from any of these endpoints.

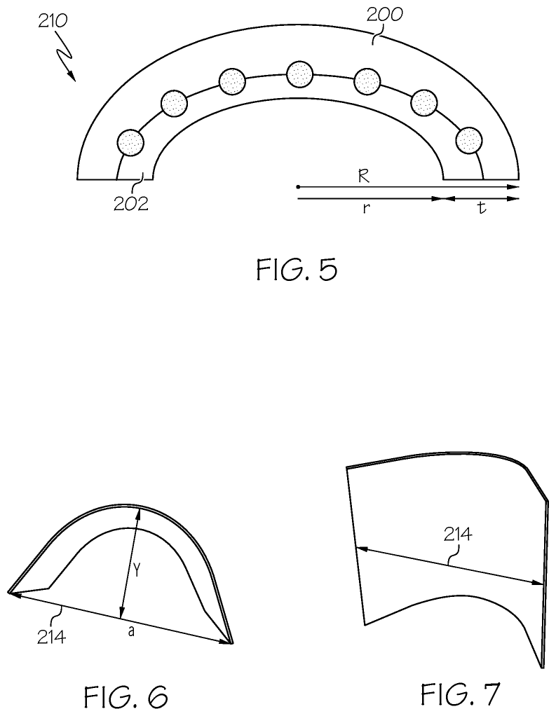

In addition to producing sufficient bond strength, the methods of laser bonding glass ceramic to metal foil disclosed herein also provide a relatively flexible package. For example, referring now to FIG. 5, the package 210 may be bent to a bend radius R, which is the sum of a thickness t of the package 210 and inner radius r. A smaller bend radius R corresponds to a tighter bend and a more flexible material. In embodiments, the bend radius may be less than or equal to 30 cm, less than or equal to 25 cm, less than or equal to 20 cm, less than or equal to 15 cm, less than or equal to 10 cm, less than or equal to 8 cm, less than or equal to 6 cm, or even less than or equal to 4 cm.

Due to this flexibility, in embodiments, the package 210 may have a parabolic cylinder shape. In embodiments, the package 210 may be a parabolic reflector antenna.

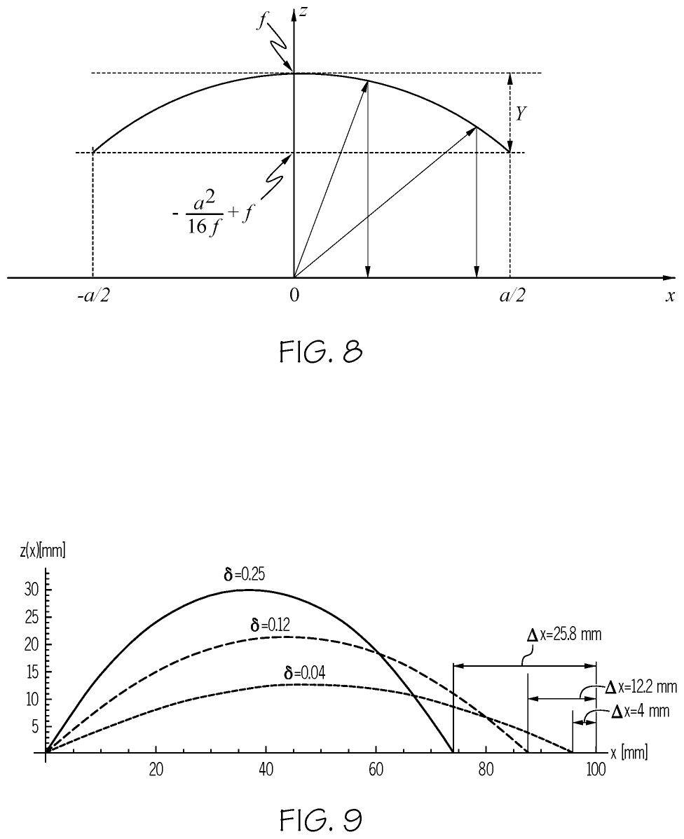

When used as a parabolic reflector antenna, the package 210 may be bent to achieve certain radiation properties and performance metrics. Bending of the package 210 may be achieved with the help of supports or may be changed dynamically. For example, referring to FIGS. 6 and 7, in embodiments, a thin elastic band, inelastic string or thread may be used to control the curvature of the package 210 and the corresponding properties and beam shape of the parabolic reflector antenna. Such a thread will not be an obstruction for a mm-wave signal with a wavelength of about 1 cm.

The parabolic reflector antenna may be placed on its focus as shown in FIG. 8, where the reflector antenna's shape is a parabolic cylinder, with “0: being the focal point where the feeder is located, a is the reflector aperture size, and ƒ is its focal length. In FIG. 8, the reflector shape is given by the following formula:

$$z ( x ) = - \frac{{x}^{2}}{4 f} + f$$

If a source of a radio wave is placed at the focal point 0, the reflected rays will stay parallel. Similarly, for the antenna operating in receiving mode, an incident plane wall will be redirected by the mirror to the focal point.

The shape obtained by mechanically bending package 210 as shown in FIG. 9 is related to the surface of the reflector as shown in FIG. 8. A plate of the size L×b and thickness d<<L, b may be bent in a shape such that relative displacement δ given by the following formula:

$$δ = \frac{Δ x}{L}$$

If δ<0.25, the resulting shape may be approximated by the following quadratic parabola:

$$z ( x ) \approx - \frac{8 \sqrt{δ} L}{π ( 1 + \frac{δ}{4} )} \frac{x ( x - a )}{{a}^{2}}$$

where a=L−Δx is the distance between the two edges of the deformed plate (i.e., aperture of antenna (FIG. 8)), which is related to the original length L and relative displacement δ as:

$$a \approx L ( 1 - δ - \frac{{δ}^{2}}{8} )$$

For such a bent shape, the focus distance ƒ defined in FIG. 8 may be expressed as:

$$f \approx \frac{π L}{32 \sqrt{δ}} ( 1 - \frac{27}{16} δ )$$

and the height of the parabola Y (FIG. 8)), which may also be used to characterize the shape of a bent plate, may be expressed as:

$$Y \approx \frac{2 L}{π} \sqrt{δ} ( 1 - \frac{5}{16} δ ) .$$

In addition to the shape of the parabolic reflector antenna achieved by bending package 210, another consideration is whether the package 210 may withstand bending without breaking. The maximum stress σ at the location of highest curvature (i.e., at the middle of the bent plate), depends on the plate size, thickness, and its mechanical properties (Young's modulus E and Poisson's ratio v) and is given by the following formula:

$$σ \approx \tilde{E} d \frac{π}{L} \sqrt{δ} ( 1 + \frac{3 δ}{16} )$$

where \tilde{E}=E/(1−v²) and d is the plate thickness.

The force F required to bend the plate to a desired shape, which depends on the geometry and material properties of the plate, is given by the following formula:

$$F \approx \tilde{E} \frac{{π}^{2} {bd}^{3}}{12 {L}^{2}} ( 1 + \frac{δ}{2} + \frac{9 {δ}^{2}}{32} ) .$$

Referring now to FIG. 10, directing the laser beam at the first contact location 204 melts the first metal foil 202 to generate plasma and form the first bond location 208 the first glass ceramic substrate 200 to the first metal foil 202. In embodiments, the first bond location 208 has a maximum bond depth 220 less than or equal to 2 μm. In embodiments, the first bond location 208 has a maximum bond depth 220 less than or equal to 2 μm, less than or equal to 1.5 μm, less than or equal to 1 μm, or even less than or equal to 0.5 μm.

Referring back to FIG. 1 and as shown in FIG. 11, the method 100 may optionally continue at blocks 106 and 108 with contacting the second surface 200b of the first glass ceramic substrate 200 with a first surface 230a of a second metal foil 230 to create a second contact location 232 between at least a portion of the second surface 200b of the first glass ceramic substrate 200 and the first surface 230a of the second metal foil 230 and conducting a second welding step by directing the laser beam (not shown) on at least a portion of the second contact location 232 to bond the first glass ceramic substrate 200 to the second metal foil 230 and form a second bond location 234 and package 236. In embodiments, the second metal foil 230 may have the same or different composition and properties as the first metal foil 202 described hereinabove. In embodiments, the laser beam used to form the second bond location 234 may have the same or different properties as the laser beam used to form the first bond location 208 as described hereinabove. In embodiments, the second bond location 234 may have the same or different properties as the first bond location 208 described hereinabove.

Referring back to FIG. 1, the method 100 may optionally continue at block 110 with forming a pattern on the first and/or second metal foils 202, 230 to form a patterned metal foil. The thickness of the metal foils 202, 230 may be such to allow for subsequent processing after welding. In embodiments, the first and/or second metal foils 202, 230 may be subjected to patterning, soldering, brazing, or electroplating. In embodiments, the first and/or second metal foils 202, 230 may be subjected to patterning prior to bonding the metal foil to a glass ceramic.

In embodiments, package 236 may be a printed antenna. For example, in embodiments, the first or second metal foil 202, 230 may be a patterned metal foil and the other of the first or second metal foil 202, 230 may be a solid electrode (i. e., non-patterned metal foil). In such embodiments, the glass ceramic substrate thickness should be chosen to correspond to a maximum radiated power and maximum efficiency. In embodiments, the glass ceramic substrate thickness d may be evaluated from the following formula:

$$d = \frac{m {0}_{}}{4 \sqrt{∈ - 1}}$$

where m is the number of surface waves excited in the substrate, [symbol] ₀ is the free-space wavelength of the radiated wave, and ∈ is substrate permittivity.

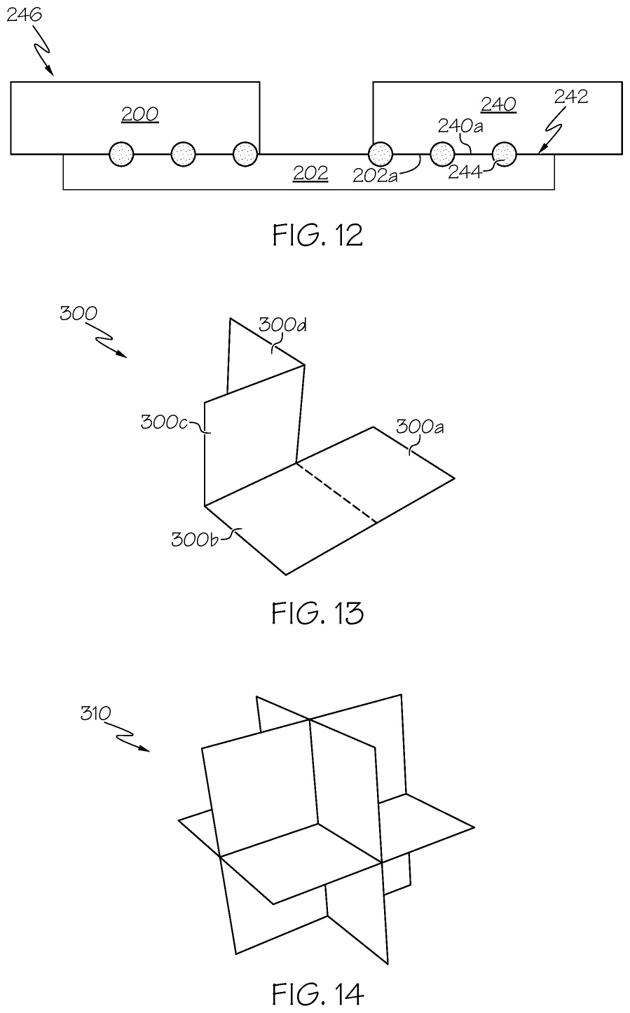

Referring back to FIG. 1 and as shown in FIG. 12, the method 100 may optionally continue at blocks 112 and 114 with contacting a first surface 240a of a second glass ceramic substrate 240 with the first surface 202a of the first metal foil 202 to create a second contact location 242 between at least a portion of the first surface 240a of the second glass ceramic substrate 240 and the first surface 202a of the first metal foil 202 and conducting a second welding step by directing the laser beam (not shown) on at least a portion of the second contact location 242 to bond the second glass ceramic substrate 240 to the first metal foil 202 and form a second bond location 244 and package 246. In embodiments, the second glass ceramic substrate 240 may have the same or different composition and properties as the first glass ceramic substrate 200 described hereinabove. In embodiments, the laser beam used to form the second bond location 244 may have the same or different properties as the laser beam used to form the first bond location 208 as described hereinabove. In embodiments, the second bond location 244 may have the same or different properties as the first bond location 208 described hereinabove.

As shown in FIG. 12, in such embodiments, at least a portion of the first surface 200a of the first metal foil 202 is not in contact with the first glass ceramic substrate 200. This allows at least for a portion of the first surface 200a of the first metal foil 202 to be contacted and bonded to the second glass ceramic substrate 240. In embodiments, the first metal foil 202 may connect the first glass ceramic substrate 200 and the second glass ceramic substrate 240. In such embodiments, the package 246 may be a corner reflector. In addition to a corner reflector, other potential applications of package 246 may include a retroreflector, which may include multiple corner reflectors bonded together. For example, as shown in FIG. 13, an individual component 300 consists of four glass ceramic substrates 300a, 300b, 300c, 300d connected by metal foils. As shown in FIG. 14, individual components may be combined to form retroreflector 310.

### EXAMPLES

In order that various embodiments be more readily understood, reference is made to the following examples, which illustrate various embodiments of the laser bonding methods described herein.

### Transmission Example

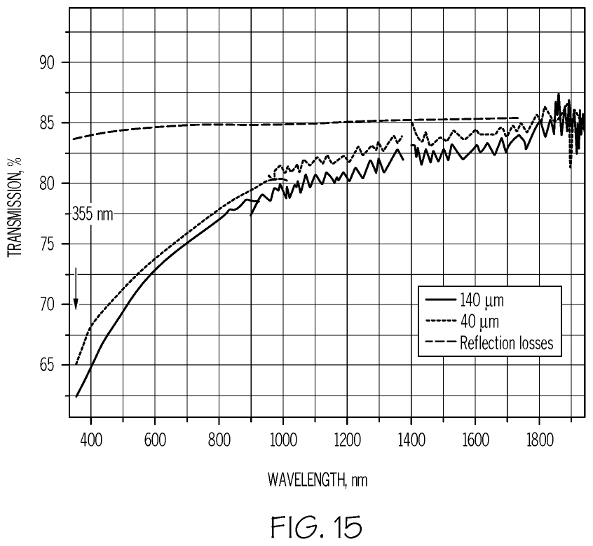

Referring now to FIG. 15, alumina substrates having thickness of 40 μm and 140 μm, respectively, had a transmission greater than or equal to 50% at a wavelength greater than or equal to 355 nm and less than or equal to 2 μm. Reflection losses shown in FIG. 15 were calculated using the Fresnel equation for reflection loss.

### Bond Strength Example

A 40 μm thick alumina ceramic substrate was secured to a 20 μm thick aluminum foil with adhesive. The alumina ceramic substrate and aluminum foil were bonded to each other using a laser beam having a wavelength of 355 nm, a repetition rate of 30 kHz, an average power of 2.5 W, and a spot size of 30 μm. The resulting package had a bond strength of greater than 5 MPa. This test was limited to the strength of adhesive used. The laser strength was higher than the strength of the adhesive. As exemplified by this bond strength example, methods of laser bonding glass ceramic to metal foil utilizing relatively thin glass ceramics and laser beams having a relatively short wavelength as described herein produces packages having sufficient bond strength.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1 A method of laser bonding glass ceramic to metal foil, the method comprising:
contacting a first surface of a first glass ceramic substrate with a first surface of a first metal foil to create a first contact location between at least a portion of the first surface of the first glass ceramic substrate and the first surface of the first metal foil; and
conducting a first welding step by directing a laser beam on at least a portion of the first contact location to bond the first glass ceramic substrate to the first metal foil and form a first bond location and a package,
wherein the first glass ceramic substrate has a thickness greater than or equal to 20 μm and less than or equal to 250 μm, and
wherein the laser beam comprises a pulsed laser comprising a wavelength greater than or equal to 250 nm and less than or equal to 2 μm.

2. The method of claim 1, wherein the first glass ceramic substrate a transmission greater than or equal to 50% at a wavelength greater than or equal to 250 nm and less than or equal to 2 μm.

3. The method of claim 1, wherein the first glass ceramic substrate comprises an alumina ceramic substrate or a zirconia ceramic substrate.

4. The method method of claim 1, wherein the first metal foil comprises an aluminum foil.

5. The method of claim 4, wherein the first metal foil further comprises a metal other than aluminum.

6. The method of method of claim 1, wherein the first metal foil has a thickness greater than or equal to 10 μm and less than or equal to 100 μm.

7. The method of method of claim 1, wherein the pulsed laser has a power density less than or equal to 6 J/cm 2 .

8. The method of method of claim 1, wherein the pulsed laser is a nanosecond pulsed laser, a picosecond pulsed laser, or a femtosecond pulsed laser.

9. The method of claim 8, wherein the pulsed laser has a pulse width greater than or equal to 1 ns and less than or equal to 30 ns.

10. The method of claim 8, wherein the pulsed laser has a pulse width greater than or equal to 10 ps.

11. The method of claim 8, wherein the pulsed laser has a pulse width less than or equal to 1 ps.

12. The method of method of claim 1, wherein the pulsed laser has a repetition rate greater than or equal to 1 kHz and less than or equal to 800 kHz.

13. The method of method of claim 1, wherein the pulsed laser has a spot size greater than or equal to 10 μm and less than or equal to 200 μm.

14. The method of method of claim 1, wherein the package has a bond strength greater than or equal to 3 MPa.

15. The method of method of claim 1, wherein the package has a bend radius less than or equal to 30 cm.

16. The method of method of claim 1, wherein the first bond location has a maximum bond depth less than or equal to 2 μm.

17. The method of an method of claim 1, wherein the package has a parabolic cylinder shape.

18. The method of claim 17, wherein the package is a parabolic reflector antenna.

19. The method of method of claim 1, further comprising:
contacting a second surface of the first glass ceramic substrate with a first surface of a second metal foil to create a second contact location between at least a portion of the second surface of the first glass ceramic substrate and the first surface of the second metal foil; and
conducting a second welding step by directing the laser beam on at least a portion of the second contact location to bond the first glass ceramic substrate to the second metal foil and form a second bond location.

20. The method of claim 19, further comprising:
forming a pattern on at least one of the first metal foil and the second metal foil to form a patterned metal foil.

21. The method of claim 20, wherein the package is a printed antenna.

22. The method of method of claim 1, further comprising:
contacting a first surface of a second glass ceramic substrate with the first surface of the first metal foil to create a second contact location between at least a portion of the first surface of the second glass ceramic substrate and the first surface of the first metal foil; and
conducting a second welding step by directing the laser beam on at least a portion of the second contact location to bond the second glass ceramic substrate to the first metal foil and form a second bond location,
wherein the first metal foil connects the first glass ceramic substrate and the second glass ceramic substrate.

23. The method of claim 22, wherein the package is a corner reflector.

24. The method of a method of claim 1, wherein the metal foil comprises a melting point less than or equal to 1200° C.

25. The method of method of claim 1, wherein the laser beam is directed at an oblique angle of incidence relative to the first glass ceramic substrate.

26. The method of claim 25, wherein the oblique angle of incidence is less than or equal to 45° .
